(19) United States
(12) Patent Application Publication
(10) Pub. No.: US 2015/0128818 A1
(43) Pub. Date: May 14, 2015

(54) Heat-Treating Equipment, In Particular For Roasting Food Products

(71) Applicant: FCD, Laburgade (FR)

(72) Inventor: Florent Cheinet, Laburgade (FR)

(21) Appl. No.: 14/400,164

(22) PCT Filed: Apr. 23, 2013
(86) PCT No.: PCT/FR2013/050901

§ 371 Date: Nov. 10, 2014

(30) Foreign Application Priority Data
May 16, 2012 (FR) 12 54502

(51) Int. Cl. A23N 12/08; A23N 12/12

(52) U.S. Cl. CPC A23N 12/083; A23N 12/125
USPC 99/474; 99/477; 99/483

(57) ABSTRACT

Heat-treating equipment for roasting food products, including a tub for receiving the product, which is associated with a stirrer and a heat source. The tube includes two vertical, coaxial and hollow cylinders, the inner cylinder defining a first wall, and the outer cylinder defining a second wall of a space having a crown-shaped cross-section, into which the product to be treated is introduced continuously from above for a loading operation that is continuous or in batches. At least one of the two walls in contact with the product is heated and a hot gas is injected into the inner hollow cylinder, so as to make the heat consistent around the product contained within the first crown-shaped space defined by said first and second walls of the tank, between which the stirrer is integrated.

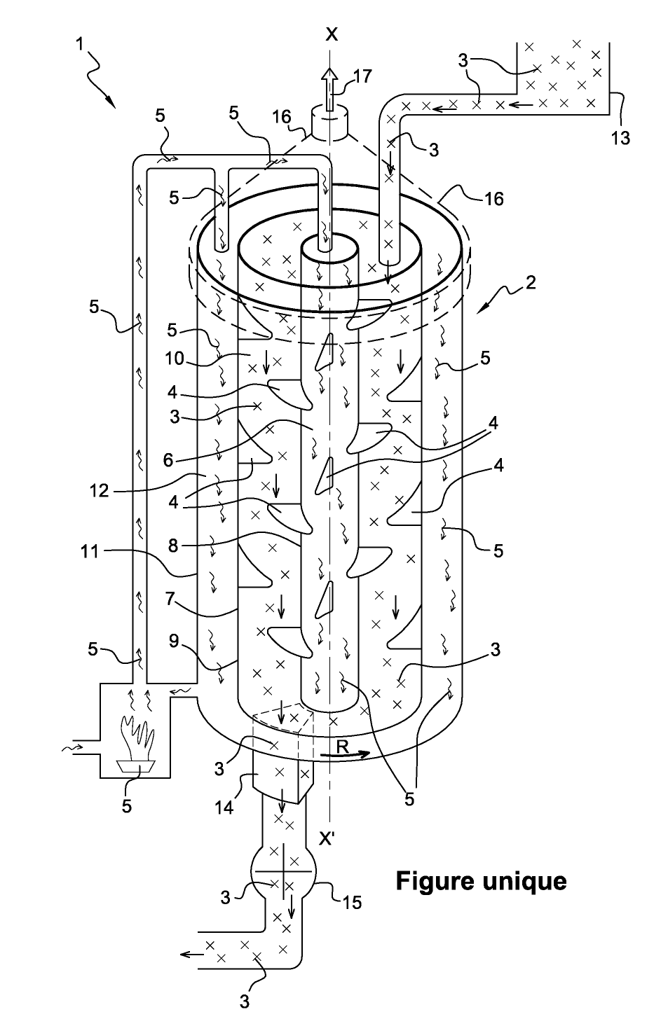

### BACKGROUND

The present invention relates to a heat treatment installation, particularly for roasting food products, including a tub for receiving the product associated with stirring means and with a heat source.

### SUMMARY

Known installations of this type are designed for example for roasting—cacao, coffee, pistachio nuts, cashew nuts, macadamia nuts, peanuts, but also powdered products.

By way of an example, for roasting cacao beans, two main technologies exist: that using a drum that is rotated about a substantially horizontal axis and below which is applied an external heat source, and that using a vertical tub wherein are placed perforated walls directed downward at an angle and staggered to form a series of funnels directing the product to be roasted toward the lower part of the tub, while holding it back slightly and while simultaneously heating it.

These systems have the disadvantage of not being able to treat all products and to be heavy consumers of energy.

This is due to the fact that the fundamental parameters in roasting are:

the temperature of the product,

the means of displacing the product inside the roaster,

the temperature of the parts in contact with the product,

the time required for the product to pass through the roaster.

Other installations are described, particularly in documents U.S. Pat. No. 2,099,634 and FR 1 558 215, but these roast the product by having it drop from tray to tray, by gravity, but always in thin layers. This is a definite shortcoming for controlling flavors and prevents pyrolytic operation due to the type of heating used, which does not allow very high temperatures to be obtained.

To correct this, according to the invention the product to be treated is introduced into the tub continuously from above, in other words it therefore operates with a permanent, that is a full, load.

Moreover, a very high temperature is obtained from several heat sources.

More precisely, the invention relates to a heat treatment installation particularly for roasting food products, including a tub for receiving the product associated with stirring means and a heat source, characterized in that the tub consist of two vertical coaxial hollow cylinders, one internal defining a first wall, the other external and defining a second wall of a space with a crown-shaped section wherein the product to be treated is introduced continuously from above for constant load operation, or discontinuously, at least one of the walls in contact with the product being heated by conduction by means of electrical resistance or a thermal fluid, a hot gas also being injected into the inner hollow cylinder, so as to homogenize the heat around the product contained in the first crown-shaped space defined by said first and second walls of the tub between which are integrated the stirring means.

The advantages of such an invention are the following:

little wear: the products rub against each other,

low energy consumption due to better stirring and a high heat exchange surface area,

continuous system which allow products to be treated in the natural or alkalinized condition.

The other advantages of a roasting unit according to the invention reside in the low construction cost. Wearing parts are reduced. The air has a rising flow and sterilizes the products during processing.

Another advantage is the guarantee of consistency in treatment, because the stirring accomplished by the blades is a guarantee that all the particles of product run against the heated walls.

In fact, the system according to the invention makes it possible to heat-treat divided solids, that it allows treatment of particles from two microns to several centimeters. It makes it possible to have divided solids react with a gas. This is a major advantage which guarantees a high degree of versatility, much sought after by users who treat several products with different sizes, densities.

The great simplicity of the system also achieves the advantage of making its maintenance easy and fast.

Naturally, the size of the installation should be adjusted depending on the required capacity.

The present invention also relates to the features that will appear in the course of the description that follows, and which should be considered in isolation or in all their technically feasible combinations.

This description, given by way of a non-limiting example, will give a better understanding of how the invention can be implemented, with reference to the appended drawings wherein:

### BRIEF DESCRIPTION OF THE DRAWINGS

The single FIGURE is a transparent perspective view of the roaster according to one embodiment of the invention.

### DETAILED DESCRIPTION

The heat treatment installation 1 designated as a whole in the single FIGURE, a roaster by way of an example, includes a reception tub 2 for a product to be treated 3, associated with stirring means 4 and a heat source 5.

According to the invention, the tub 2 consists of two vertical coaxial hollow cylinders 6, 7, one internal 6 defining a first wall 8, the other external 7 defining a second wall 9 of a space 10 with a crown-shaped section wherein the product to be treated 3 is introduced continuously from above for constant load operation, or discontinuously, at least one of the two walls 8, 9 in contact with the product 3 being heated 5 by conduction by means of electrical resistance or a thermal fluid, a hot gas 5 also being injected into the inner hollow cylinder 6 so as to homogenize the heat 5 around the product 3 contained in the first crown-shaped space 10 defined by said first and second walls 8, 9 of the tub 2, between where are integrated the stirring means 4.

Preferably and according to the present example shown in the single FIGURE, the external cylinder 7 is itself lined with a wall 11, constituting a third wall of the tub 2, forming with the second wall 9 a second vertical hollow space 12, concentric with the first, having a crown-shaped section. Heating of the walls can be accomplished by electrical resistance heaters stuck to the inner surface, by a thermal fluid circulating against the inside of the wall, or a heated gas 5 circulating against the side opposite the product of the walls of the cylinders. The cylinder is heated by conduction and thus transmits its heat to the product.

According to another feature of the invention, the hot gas 5 is injected into the second crown-shaped space 12 of the outer hollow cylinder 7 and into the inner hollow cylinder 6, from an external source 5 and in a closed circuit injecting the hot gas that it generates into the upper portions of said cylinders 7, 6 to then recover it in their lower portions after cooling and recycle it.

The heating method can be electricity, a heat transport fluid, hot air, steam or any other means.

Implementation of the stirring means 4 is accomplished by driving in rotation “R” at least one of the cylinders 6, 7 comprising said means.

Moreover, the stirring means 4 can consist of a continuous helix or of alternate blades arranged in a helix, implemented on the first wall 8 of the inner cylinder 6 and/or on the second wall 9 of the outer cylinder 7, in contact with the product to be treated 3, driving in rotation “R” of the corresponding cylinder(s) 6, 7 occurring about their axis XX', in one and the same direction or in opposite directions.

According to a variant embodiment, the stirring means 4 consist of a rotary agitator (not shown) placed at the center of the product 3 between the two cylinders 6, 7, these being fixed.

Likewise the tub 2 is continuously supplied with products to be treated 3 by the top portion of the space 10 delimited by the first wall 8 of the inner cylinder 6 and the second wall 9 of the outer cylinder 7, by means of a feed rate regulator 13, said space 10 comprising at its lower portion a discharge hatch 14 for the product 3, associated with a discharge rate regulator 15, the relative regulated feed and delivery speeds of the product 3 being such as to allow descent by gravity during which it progressively heats and transforms its moisture into steam. This creates a rising flow having the effect of sterilizing the product 3, which contributing to its heating.

The tub 2 is capped, at its upper portion by an extraction hood 16 associated with an air flow regulator 17.

1.-8. (canceled)

9. An installation for heat treatment for roasting a food product, comprising a tub to receive the product; a stirrer; and a heat source, wherein the tub includes two vertical coaxial hollow cylinders, with a first wall and a second wall spaced from the first wall to define a space with a crown-shaped section, wherein the product is introduced from above, at least one of the walls in contact with the product is heated, and wherein at least one of the hollow cylinders receives a hot gas to homogenize the heat around the product contained in a crown-shaped space defined by said first and second walls of the tub between which is integrated the stirrer.

10. The installation according to claim 9, wherein the outer cylinder is lined with a wall constituting a third wall of the tub, forming with the second wall a second vertical hollow space, concentric with the first, with a crown-shaped section to receive injected hot gas.

11. The installation according to claim 9, wherein hot gas is injected into a crown-shaped space of the outer hollow cylinder and into the inner hollow cylinder from an external source and in a closed circuit injecting the hot gas that it generates into upper portions of the cylinders, to recover it in lower portions after cooling and recycle it.

12. The installation according to claim 9, wherein the stirrer is rotated by rotation of at least one of the cylinders.

13. The installation according to claim 9, wherein the stirrer comprises a continuous helix or alternate blades arranged in a helix, provided on a first wall of the inner cylinder or on a second wall of the outer cylinder in contact with the product to be treated, the driving in rotation of corresponding cylinder(s) occurring about a longitudinal axis.

14. The installation according to claim 9, wherein the stirrer comprises a rotary agitator placed at the center of the product between the two cylinders.

15. The installation according to claim 9, wherein the tub is fed continuously with product to be treated through an upper portion of a space delimited by a first wall of an inner cylinder and a second wall of an outer cylinder, by a feed rate regulator, the space comprising, in its lower portion, a discharge hatch for the product with the hatch associated with a discharge rate regulator, the relative regulated feed and discharge rates of the product being such as to allow descent by gravity, during which the product heats progressively and transforms its moisture into steam, this creating a rising flow having the effect of sterilizing the product while also contributing to heating it.

16. The installation according to claim 9, wherein the tub is capped, on its upper portion, by an extraction hood associated with an air flow regulator.
